(19) United States
(12) Patent Application Publication
(10) Pub. No.: US 2014/0335318 A1
(43) Pub. Date: Nov. 13, 2014

(54) INK BASED LABEL FOR REPAIRING A PATTERN VOID

(71) Applicant: J. Patrick Epling, Mufreesboro, TN (US)

(72) Inventor: J. Patrick Epling, Mufreesboro, TN (US)

(21) Appl. No.: 13/889,108

(22) Filed: May 7, 2013

(51) Int. Cl. B44C 1/10

(52) U.S. Cl. CPC B44C 1/105
USPC 428/172; 156/94; 428/195.1; 428/211.1; 428/201

(57) ABSTRACT

A pattern is transferred to a surface of an object via dip transfer printing. Dip transfer printing can leave a void in the pattern on the surface of the object. An ink based label is used to repair (i.e., cover or fill) the void. The ink based label includes an ink layer and an adhesive layer. The ink layer includes a printing of each color of a four-color printing process forming an image representative of a major element of the pattern. The adhesive layer attaches the ink layer to the void in the pattern on the surface of the object. Optionally, the ink based label includes a backing layer between the ink layer and the adhesive layer.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to decorating a surface of an object with a pattern including a plurality of major elements. More particularly, this invention pertains to covering or filling a void in a pattern applied to a surface of an object by dip transfer printing.

Dip transfer printing is useful for applying a pattern or image to an outer surface of an object that is not completely flat like paper, film, vinyl, etc. An image is printed on a water soluble polymer film in solvent based ink. The film is then floated on water to dissolve the water soluble film, leaving the solvent based ink with its intended image or pattern floating on top of the water. The ink is sprayed with a solvent activator, and the object on which the pattern or image is to be transferred is pressed down through the surface of the water, through the ink. A four color printing process is used to produce a photographic quality pattern (i.e., image). Dip transfer printing is further described in U.S. Pat. No. 6,935,230, the disclosure of which is incorporated by reference herein in its entirety, U.S. Pat. No. 6,953,511, the disclosure of which is incorporated by reference herein in its entirety, U.S. Patent Pub. No. 2005/0139097, the disclosure of which is incorporated by reference herein in its entirety, and U.S. Patent Pub. No. 2008/0053603 the disclosure of which is incorporated by reference herein in its entirety.

When dip transfer printing, if the object is pressed through the surface of the water (and the ink floating on the surface of the water) faster than the ink can be pulled onto the surface of the object by the surface tension of the water and ink, then a void is created in the pattern being transferred onto the object. That is, if the water (or other film solvent) contacts the surface of the object before the ink, a void is created. Voids may be filled by hand painting the voided area, but these paints may not exactly match the inks. For bigger voids, this manner of void repair is too obvious to be useful, especially for larger voids. Voids may also be repaired by spraying the void with activated ink of the type used to form and transfer the pattern (i.e., image) to the surface of the object. This has the benefit of matching the existing ink, but the overspray of the paint gun (i.e., airbrush or high volume low pressure paint gun) makes continuity with the pattern and maintaining the sharpness of the images in the pattern impossible which is especially problematic for larger voids. Brushing activated ink (or just activator) onto the void is possible, but the painter is limited to one color because the activator will cause the inks it touches to mix (e.g., at the edges of the void). Mixing colors in a four-color printing process generally results in black. Thus, brushing activated ink or activator onto the void generally results in a black outline around the filled void. Printed vinyl stickers have been used to cover voids, but the vinyl causes the ink to look different than the ink transferred directly to the surface of the object. Additionally, the vinyl is thick and has edges that stand out from the surface of the object.

### BRIEF SUMMARY OF THE INVENTION

Aspects of the present invention provide a method and apparatus for covering or filling a void in a pattern applied to a surface of an object by dip transfer printing by applying an ink layer to the void via an adhesive layer.

In one aspect, a method is provided for repairing a void in a pattern on a surface of an object. The pattern includes a plurality of major elements. The major elements of the plurality of major elements making up the pattern is selected as a function of a portion of the pattern adjacent the void. An ink based label corresponding to the selected major element is wetted. Being based label includes an ink layer, a substrate, and an adhesive layer. The ink layer forms an image representative of the selected major element. The substrate is operable to support the ink layer, and the adhesive layer is on the ink layer and operable to attach the ink layer to the surface of the object. The ink based label is applied to the void and the portion of the pattern adjacent the void such that the adhesive layers in contact with the surface of the object.

In another aspect, an ink-based label is operable to repair a void in a pattern on a surface of an object. The pattern includes a plurality of major elements. The ink based label includes an ink layer, a substrate, and an adhesive layer. The ink layer includes a printing of each color of a four-color printing process printed on top of one another to form an image representative of a major element of the plurality of major elements of the pattern. The substrate is operable to support the ink layer. The adhesive layer is operable to attach the ink layer to the surface of the object.

In another aspect, an object has a surface with a pattern applied thereto. The application of the pattern to the surface of the object left a void in the pattern. The object includes a film applied to the surface of the object on the void. The film includes an ink layer and an adhesive layer. The ink layer includes a printing of each color of a four-color printing process printed on top of one another to form an image representative of a major element of the pattern. The adhesive layer attaches the ink layer to the void and to a portion of the surface of the object adjacent the void.

### BRIEF DESCRIPTION OF THE SEVERAL VIEWS OF THE DRAWINGS

FIG. 1 is a plan view of a pattern including a plurality of major elements.

FIG. 2 is an isometric perspective view of an object having a surface with a pattern applied thereto with a void.

FIG. 3 is an isometric perspective view of an object having a surface with a pattern applied thereto with a void and an ink-based label covering the void.

FIG. 4 is a plan view of an ink based label having a backing layer.

FIG. 5 is a cross sectional view of the ink based label of FIG. 4 through one of the major elements represented thereon.

FIG. 6 is a plan view of an ink based label without a backing layer.

FIG. 7 is a cross sectional view of the ink based label of FIG. 6 through one of the major elements represented thereon.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

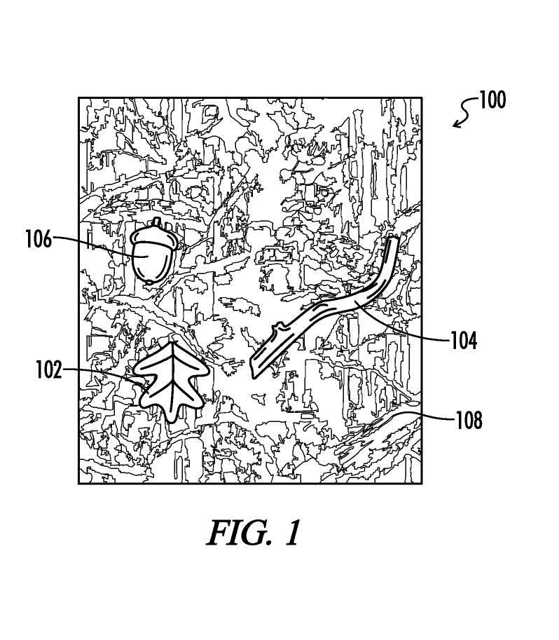

Referring to FIG. 1, a pattern 100 includes a plurality of major elements. The pattern 100 may be, for example, a camouflage pattern such as Mossy Oak Breakup. The pattern 100 includes a first major element 102, a second major element 104, and a third major element 106. Optionally, the pattern 100 may include a background 108 on which the major elements 102, 104, and 106 reside and blend into. In the example of Mossy Oak Breakup camouflage, major elements may include, for example, leaves, branches, acorns, sticks, reeds, grass, or dirt. The background 108 may be, for example, tree bark or a leaf covered ground.

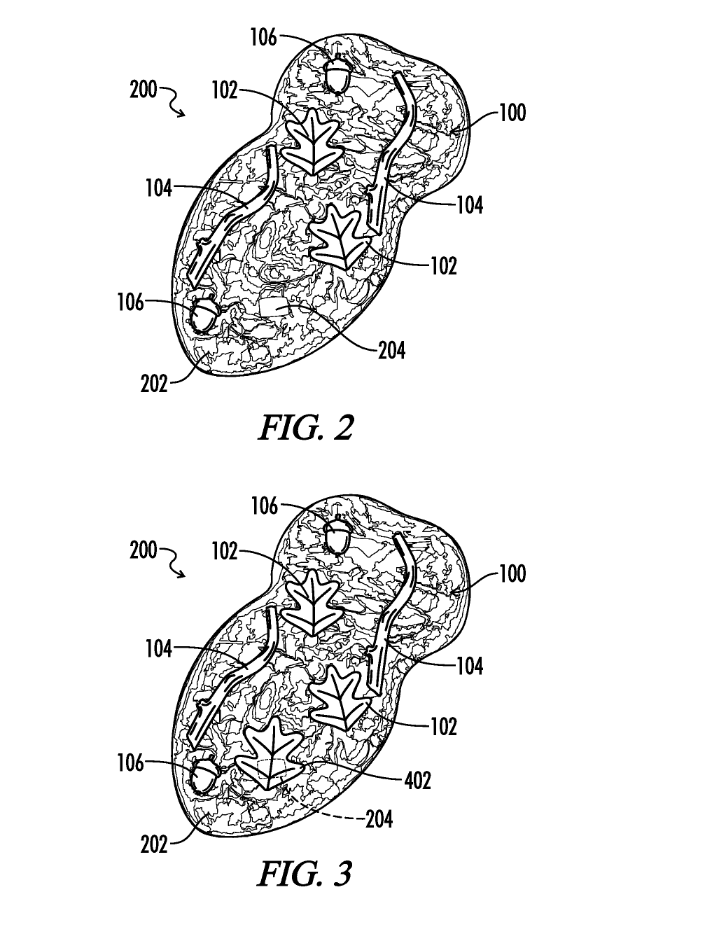

Referring to FIG. 2, an object 200 has a surface 202 to which the pattern 100 has been applied via dip transfer printing. Application of the pattern 100 to the surface 202 of the object 200 is shown leaving a void 204.

Referring to FIG. 3, the object 200 is shown with the void 204 repaired or corrected (i.e., covered or filled) with an ink based label 402 representative of a major element (e.g., the first major element 102) of the pattern 100. The portion of ink based label 402 on the surface 202 of the object 200 may be referred to as a film. The film includes an ink layer 502 and an adhesive layer 506. The ink layer 502 is a printing of each color of a four-color printing process printed on top of one another to form an image representative of the major element 102 of the pattern 100. Areas of the ink layer 502 will necessarily include more or less of a certain color ink of the four color ink print in order to represent the major element 102 of the pattern 100. A given area of the ink layer 502 may include only one color of the four-color printing process. It is also contemplated that the ink layer 502 may be a single color of ink, the single color being one of the colors of the four-color process or a premixed color formed from two or more of the four colors of ink of the four-color printing process. This may be beneficial, for example, to correct a small area (i.e., a portion) of the major element 102 of the pattern 100. It is also contemplated that the ink layer 502 may be of a different type of ink than the four-color printing process. However, such an ink may stand out to an observer more than inks matching the four-color printing process used to generate the pattern 100. The adhesive layer 506 attaches the ink layer 502 to the void 204 and to a portion of the surface 202 of the object 200 adjacent to the void 204. Optionally, the film may also include a backing layer 508 of white ink between the adhesive layer 506 and the ink layer 502.

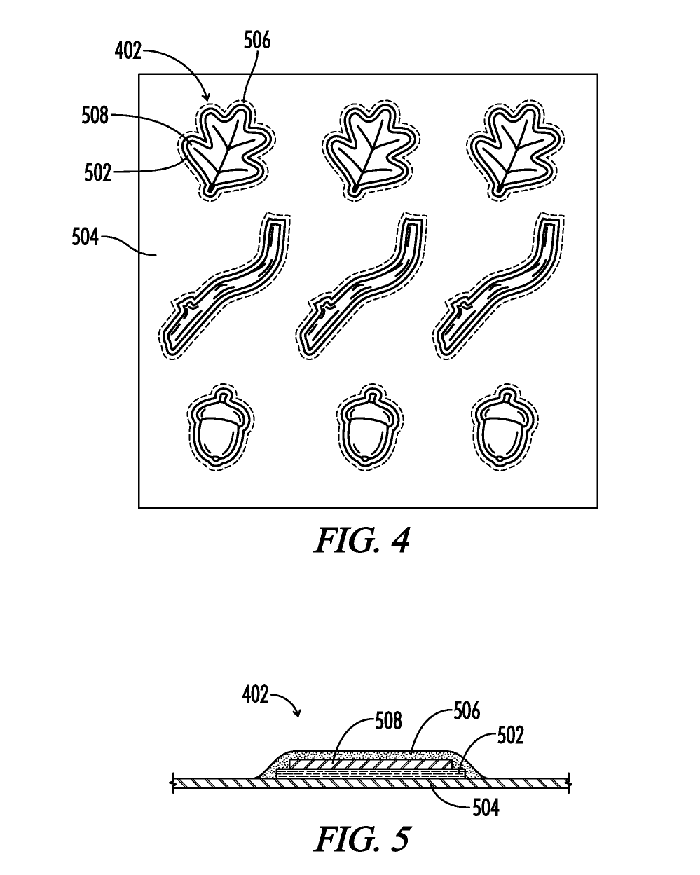

Referring to FIGS. 4 and 5, one embodiment of an ink based label 402 operable to correct or repair the void 204 in the pattern 100 on the surface 202 of the object 200 is shown. The ink based label 402 includes an ink layer 502, a substrate 504, and adhesive layer 506, and a backing layer 508. Being based label is applied to the surface 202 of the object 200 by applying a solvent to the void 204 in the pattern 100 on the surface 202 of the object 200 and placing the adhesive layer 506 of the ink based label 402 on the void 204 in the pattern 100 on the surface 202 of the object 200. The ink based label 402 has a first side and a second side. The ink layer 502, the adhesive layer 506, and the backing layer 508 are on a first side of the substrate 504. In one embodiment, the second side of the substrate opposite the first side includes registration marks printed thereon. The registration marks include an outline of the image representative of the major element formed by the ink layer 502, and the outline formed by the registration marks are aligned with an outline of the ink layer 502 forming the image representative of the major element of the pattern 100.

The ink layer 502 includes a printing of each color of a four-color printing process printed on top of one another to form an image representative of the major element 102 of the plurality of major elements of the pattern 100. The ink layer 502 is printed onto the substrate 504.

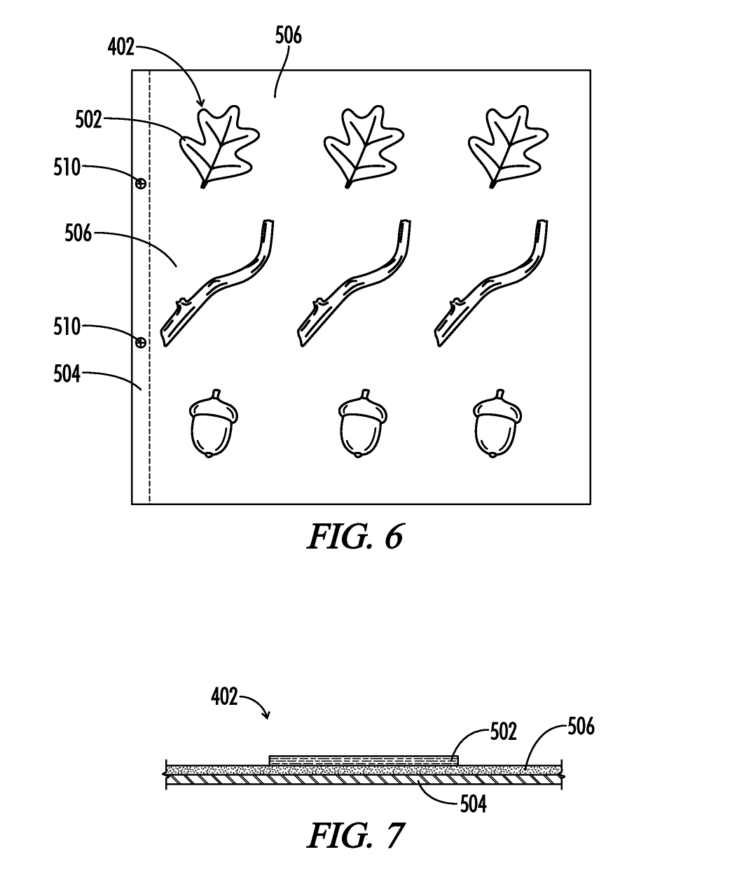

The substrate 504 supports the ink layer 502. In one embodiment, the substrate is a paper-based material coated with a releasing agent such as wax or a polymer to which the ink layer 502 and adhesive layer 506 form a relatively weak bond. In this usage, a relatively weak bond is a bond that can be broken with a solvent (e.g., water) such that the ink layer 502, backing layer 508, and adhesive layer 506 may be separated from the substrate 504 and attach to the surface 202 of the object 200. As shown in FIGS. 4 and 6, the substrate 504 may be common to a plurality of ink-based labels 402 such that the substrate 504 can be cut into a plurality of sections to produce a plurality of ink-based labels.

The adhesive layer 506 is operable to attach the ink layer 502 to the surface 202 of the object 200 on the void 204. The adhesive layer 506 is printed (e.g., sprayed) onto the backing layer 508. In one embodiment, the adhesive layer 506 is activated by a solvent, and the solvent is water. That is, the adhesive in the adhesive layer 506 prepares to adhere to the surface 202 of the object 200 with the application of water to the adhesive layer 506. The presence of the solvent (e.g., water) may also aid in releasing the adhesive layer 506 from the substrate 504.

The backing layer 508 is a white ink layer sprayed or printed onto the ink layer 502 such that the backing layer 508 is between the ink layer 502 and the adhesive layer 506. The white backing layer 508 improves coloration of the ink layer 502 once applied to the surface 202 of the object 200 by substantially preventing an observer from being able to see a portion of the pattern 100 and adjacent the void 204 on the surface 202 of the object 200.

The ink layer 502, backing layer 508, and adhesive layer 506 form a film operable to separate from the substrate 504 with the application of a solvent (e.g., water) to the ink based label 402 and attached to the surface 202 of the object 200 having the void 204 in the pattern 100. When applied to the surface 202 of the object 200, the adhesive layer 506 and backing layer 508 are the only layers of material between the ink layer 502 and the surface 202 of the object 200. In one embodiment, water is applied to the surface 202 of the object 200, the optional registration marks on the second side of the substrate 504 are used to align the ink based label 402 with the void 204, and the first side of the substrate 504 is pressed against the surface 202 of the object 200. The water on the surface 202 of the object 200 activates the adhesive in the adhesive layer 506, and the adhesive attaches the backing layer 508 and ink layer 502 to the surface 202 of the object 200, repairing (i.e., covering, filling, or correcting) the void 204.

In one embodiment, an outline of the backing layer 508 is recessed from an outline of the ink layer 502. Additionally, the outline of the ink layer 502 is recessed from an outline of the adhesive layer 506 such that the adhesive layer 506 covers the backing layer 508 and contacts a portion of the ink layer 502 between the outline of the backing layer 508 and the outline of the ink layer 502. A portion of the adhesive layer 506 may also extend onto the substrate 504 while the film is attached to the substrate 504. This causes the ink based label 402 to have tapered edges when applied to the surface 202 of the object 200 helping to blend the ink based label 402 into the pattern 100 and surface 202 of the object 200.

Referring to FIGS. 6 and 7, an embodiment of an ink based label 402 without a backing layer 508 is shown. In this embodiment, the ink layer 502 and adhesive layer 506 form the film which is operable to separate from the substrate 504 with the application of water to being based label 402. The film is operable to attach to the surface 202 of the object 200 such that the adhesive layer 506 is the only layer between the ink layer 502 and the surface 202 the object 200. In this embodiment, being based label 402 is applied to the surface 202 of the object 200 by substantially immersing the ink based label 402 in a container solvent (e.g., water). The film (i.e., the adhesive layer 506 and the ink layer 502) is slipped off of or otherwise separated from the substrate 504 and placed on the void 204 and the pattern 100 on the surface 202 of the object 200 with the adhesive layer 506 against the surface 202 of the object 200. In this embodiment, the adhesive layer 506 substantially covers the first side of the substrate 504, and the ink layer is printed onto the adhesive layer 506. To separate one ink based label 402 from additional ink-based labels having the substrate 504 in common and trim the adhesive layer 506 to the outline of the ink layer 502, a user or machine trims around an outline of the ink-based layer 502. Optionally, layer printing registration marks 510 may be preprinted on the substrate 504 such that the adhesive layer 506 may be printed with an outline substantially coextensive with the outline of the ink layer 502.

In one embodiment, a method of repairing (i.e., correcting, filling, or covering) a void 204 and a pattern 100 on a surface 202 of an object 200 wherein the pattern 100 includes a plurality of major elements begins with selecting a major element 102 of the plurality of major elements as a function of a portion of the pattern 100 adjacent the void 204. The method continues with wetting an ink based label 402 corresponding to the selected major element 102. The ink based label 402 includes an ink layer 502, a substrate 504, and an adhesive layer 506. The ink layer 502 forms an image representative of the selected major element 102. In one embodiment, the ink layer 502 includes a printing of each color of a four-color printing process printed on top of one another to form the image representative of the selected major element 102 of the pattern 100. The substrate 504 supports the ink layer 502, and the adhesive layer 506 on the ink layer 502 is operable to attach the ink layer 502 to the surface 202 the object 200. The ink based label 402 is applied to the void 204 and the portion of the pattern 100 adjacent the void 204 such that the adhesive layer 506 is in contact with the surface 202 of the object 200. In one embodiment, the substrate 504 of being based label 402 has a plurality of major elements there on, and the method further includes cutting through the substrate 504 adjacent the ink layer 502 (e.g., along outline of the ink layer 502) representative of the selected major element 102. In one embodiment, the pattern 100 includes the background 108. The pattern 100 is applied to the surface 202 of the object 200 by applying a primer to the surface 202 of the object 200 wherein the primer is operable to link (e.g., chemically bond) to activated ink molecules. Ink representative of the pattern 100 is placed on a surface of a body of water, and an activator is sprayed onto the ink to activate the ink before passing the object 200 into the body of water. The object 200 is passed into the body of water through the activated ink on the surface of the body of water to transfer the image (i.e., the pattern 100) onto the surface 202 of the object 200.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful INK BASED LABEL FOR REPAIRING A PATTERN VOID it is not intended that such references be construed as limitations upon the scope of this invention except as set forth in the following claims.

What is claimed is:

1. A method of repairing a void in a pattern on a surface of an object, wherein the pattern comprises a plurality of major elements, said method comprising:
selecting a major element of the plurality of major elements as a function of a portion of the pattern adjacent the void;
wetting an ink based label corresponding to the selected major element, wherein the ink based label comprises:
an ink layer forming an image representative of the selected major element,
a substrate operable to support the ink layer; and
an adhesive layer on the ink layer operable to attach the ink layer to the surface of the object; and
applying the ink based label to the void and the portion of the pattern adjacent the void such that the adhesive layer is in contact with the surface of the object.

2. The method of claim 1, wherein the ink layer comprises a printing of each color of a four color printing process printed on top of one another to form the entire image representative of the selected major element of the pattern.

3. The method of claim 1, wherein the substrate of the ink based label corresponding to the selected major element has a plurality of major elements thereon; and
the method further comprises cutting through the substrate adjacent the ink layer representative of the selected major element.

4. The method of claim 1, wherein:
the substrate is paper based;
the adhesive layer substantially covers a first side of the substrate;
the ink layer is printed onto the adhesive layer;
wetting the ink based label comprises substantially immersing the ink based label in a container of solvent; and
applying the ink based label to the void comprises:
slipping a film off of the substrate, said film comprising the adhesive layer together with the ink layer; and
placing the film on the void in the pattern on the surface of the object with the adhesive layer against the surface of the object.

5. The method of claim 1, wherein:
the adhesive layer is water activated; and
wetting the ink based label comprises exposing the ink based label to water.

6. The method of claim 1, wherein:
the substrate is paper based;
the ink layer is printed onto the substrate;
the ink based label further comprises a backing layer applied to the ink layer, wherein the backing layer is white;
the adhesive layer is sprayed onto the white backing layer; and
wetting the ink based label and applying the ink based label comprise:
applying a solvent to the void in the pattern on the surface of the object; and
placing the adhesive layer of the ink based label on the void in the pattern on the surface of the object.

7. The method of claim 1, wherein:
the substrate is paper based;
the ink layer is printed onto the substrate;
the ink based label further comprises a backing layer printed on the ink layer, wherein the backing layer is white;
the adhesive layer is sprayed onto the white backing layer; and
wetting the ink based label and applying the ink based label comprises:
applying a solvent to the void in the pattern on the surface of the object; and
placing the adhesive layer of the ink based label on the void in the pattern on the surface of the object; and
the ink based label further comprises registration marks printed on a second side of the substrate opposite a first side of the substrate nearest the ink layer, backing layer, and adhesive layer, wherein said registration marks comprise an outline of the selected major element and the outline of the selected major element is aligned with an outline of the ink layer forming the image representative of the major element of the pattern.

8. The method of claim 1, wherein the pattern further comprises a background; and the pattern is applied to the surface of the object by:
applying a primer to the surface of the object, said primer operable to link to activated ink molecules;
placing ink on a surface of a body of water, wherein the ink is representative of the pattern;
spraying activator on the ink to activate the ink before passing the object into the body of water; and
passing the object into the body of water through the activated ink on the surface of the body of water.

9. An ink based label operable to repair a void in a pattern on a surface of an object, wherein the pattern comprises a plurality of major elements, said ink based label comprising:
an ink layer comprising a printing of each color of a four color printing process printed on top of one another to form an image representative of a major element of the plurality of major elements of the pattern;
a substrate operable to support the ink layer; and
an adhesive layer operable to attach the ink layer to the surface of the object.

10. The ink based label of claim 9, wherein the ink layer and adhesive layer form a film operable to separate from the substrate with the application of water to the ink based label and attach to the surface of the object having the void in the pattern, wherein the adhesive layer is the only layer between the ink layer and the surface of the object.

11. The ink based label of claim 9, further comprising a backing layer between the ink layer and the adhesive layer, wherein:
the ink layer, adhesive layer, and backing layer form a film operable to separate from the substrate with the application of water to the ink based label and attach to the surface of the object having the void in the pattern;
the backing layer is a white ink layer; and
the adhesive layer and backing layer are the only layers between the ink layer and the surface of the object.

12. The ink based label of claim 9, wherein:
the substrate of the ink based label has a plurality of major elements of the pattern such that the substrate is operable to be cut into a plurality of sections to produce a plurality of ink based labels; and
the substrate is coated with a releasing agent, wherein said releasing agent is wax.

13. The ink based label of claim 9, wherein:
the substrate is paper based;
the adhesive layer substantially covers a first side of the substrate;
the ink layer is printed onto the adhesive layer;
the ink based label is operable to be applied to the surface of the object by:
substantially immersing the ink based label in a container of solvent; and
slipping a film off of the substrate, said film comprising the adhesive layer together with the ink layer; and
placing the film on the void in the pattern on the surface of the object with the adhesive layer against the surface of the object.

14. The ink based label of claim 13, wherein the adhesive layer is activated by the solvent, and the solvent is water.

15. The ink based label of claim 9, wherein:
the substrate is paper based;
the ink layer is printed onto the substrate;
the ink based label further comprises a backing layer printed on the ink layer, wherein the backing layer is a white ink layer;
the adhesive layer is sprayed onto the white backing layer; and
the ink based label is operable to be applied to the surface of the object by:
applying a solvent to the void in the pattern on the surface of the object; and
placing the adhesive layer of the ink based label on the void in the pattern on the surface of the object.

16. The ink based label of claim 15, wherein an outline of the backing layer is recessed from an outline of the ink layer, and the outline of the ink layer is recessed from an outline of the adhesive layer such that the adhesive layer covers the backing layer and contacts a portion of the ink layer between the outline of the backing layer and the outline of the ink layer.

17. The ink based label of claim 9, wherein:
the substrate is paper based;
the ink layer is printed onto the substrate;
the ink based label further comprises a backing layer applied to the ink layer, wherein the backing layer is a white ink layer;
the adhesive layer is sprayed onto the white backing layer; and
the ink based label is operable to be applied to the surface of the object by:
applying a solvent to the void in the pattern on the surface of the object; and
placing the adhesive layer of the ink based label on the void in the pattern on the surface of the object; and
the ink based label further comprises registration marks printed on a second of the substrate opposite a first side of the substrate nearest the ink layer, backing layer, and adhesive layer, wherein said registration marks comprise an outline of the image representative of the major element formed by the ink layer and the outline of the registration marks is aligned with an outline of the ink layer forming the image representative of the major element of the pattern.

18. The ink based label of claim 17, wherein the adhesive layer is activated by the solvent, and the solvent is water.

19. An object having surface with a pattern applied thereto, wherein the application of the pattern to the surface of the object left a void in the pattern, said object comprising:
a film applied to the surface of the object on the void, said film comprising:
an ink layer comprising a printing of each color of a four color printing process printed on top of one another to form an image representative of a major element of the pattern; and
an adhesive layer attaching the ink layer to the void and to a portion of the surface of the object adjacent to the void.

20. The object of claim 19, further comprising:
a backing layer between the adhesive layer and the ink layer, wherein:
the backing layer is a white ink layer;
an outline of the ink layer is recessed from an outline of the adhesive layer; and
an outline of the backing layer is recessed from an outline of the ink layer.
